(19) United States
(12) Patent Application Publication
(10) Pub. No.: US 2025/0362551 A1
(43) Pub. Date: Nov. 27, 2025

(54) Electro-Optical Device, Electro-Optical Panel, And Driver

(71) Applicant: SEIKO EPSON CORPORATION, Tokyo (JP)

(72) Inventor: Kazuaki TANAKA, Chino (JP)

(21) Appl. No.: 19/215,503

(22) Filed: May 22, 2025

(30) Foreign Application Priority Data
May 23, 2024 (JP) 2024-083741

(51) Int. Cl. G02F 1/1345; G02F 1/133; G02F 1/1343

(52) U.S. Cl. CPC G02F 1/13452; G02F 1/13306; G02F 1/134318

(57) ABSTRACT

An electro-optical device includes an electro-optical panel and a driver. The electro-optical panel includes a first substrate, a second substrate, a first segment electrode group arranged at the first substrate, a second segment electrode group arranged at the second substrate, a first common electrode group arranged at the second substrate and facing the first segment electrode group, and a second common electrode group arranged at the first substrate and facing the second segment electrode group. The driver includes a first terminal group continuously arranged along a first side of the driver and a second terminal group continuously arranged along the first side. The first terminal group includes a first segment terminal group and a first common terminal. The second terminal group includes a second segment terminal group and a second common terminal.

### BACKGROUND

The present application is based on, and claims priority from JP Application Serial Number 2024-083741, filed May 23, 2024, the disclosure of which is hereby incorporated by reference herein in its entirety.

### 1. Technical Field

The present disclosure relates to an electro-optical device, an electro-optical panel, a driver, and the like.

### 2. Related Art

JP-A-2001-100239 discloses a liquid crystal display panel including a first transparent electrode substrate and a second transparent electrode substrate facing each other, and multiple dots. The dots each include a segment electrode and a common electrode disposed so as to face each other, one of the electrodes disposed at the first transparent electrode substrate, the other electrode disposed at the second transparent electrode substrate. In each of the transparent electrode substrates, the segment electrodes and the common electrodes are mixed with each other. That is, some of the multiple dots are so configured that the segment electrodes are disposed at the first transparent electrode substrate and the common electrodes are disposed at the second transparent electrode substrate. The remaining dots are so configured that the common electrodes are disposed at the first transparent electrode substrate and the segment electrodes are disposed at the second transparent electrode substrate.

JP-A-2001-100239 is an example of the related art.

Depending on the arrangement of terminals of the electro-optical panel and a driver, efficient wiring cannot be achieved in the electro-optical panel, so that there is a possibility of an insufficient advantage of a decrease in the wiring region or an increase in the display region. JP-A-2001-100239 mentioned above describes neither the arrangement of the terminals on the liquid crystal display panel nor the arrangement of the terminals of the driver that drives the liquid crystal display panel.

### SUMMARY

An aspect of the present disclosure relates to an electro-optical device including an electro-optical panel; and a driver configured to drive the electro-optical panel, the electro-optical panel including a transparent first substrate, a second substrate disposed so as to face the first substrate, a first segment electrode group arranged at the first substrate, a second segment electrode group arranged at the second substrate, a first common electrode group arranged at the second substrate and facing the first segment electrode group, and a second common electrode group arranged at the first substrate and facing the second segment electrode group, the driver including a first terminal group continuously arranged along a first side of the driver, a second terminal group continuously arranged along the first side of the driver, the first terminal group including a first segment terminal group configured to supply a segment driving signal to the first segment electrode group, and a first common terminal configured to supply a common driving signal to the first common electrode group, the second terminal group including a second segment terminal group configured to supply a segment driving signal to the second segment electrode group, and a second common terminal configured to supply a common driving signal to the second common electrode group.

Another aspect of the present disclosure relates to a driver configured to drive an electro-optical panel, the driver including: a first terminal group continuously arranged along a first side of the driver; and a second terminal group continuously arranged along the first side of the driver, the electro-optical panel including a transparent first substrate, a second substrate disposed so as to face the first substrate, a first segment electrode group arranged at the first substrate, a second segment electrode group arranged at the second substrate, a first common electrode group arranged at the second substrate and facing the first segment electrode group, and a second common electrode group arranged at the first substrate and facing the second segment electrode group, the first terminal group including a first segment terminal group configured to supply a segment driving signal to the first segment electrode group, and a first common terminal configured to supply a common driving signal to the first common electrode group, the second terminal group including a second segment terminal group configured to supply a segment driving signal to the second segment electrode group, and a second common terminal configured to supply a common driving signal to the second common electrode group.

A still another aspect of the present disclosure relates to an electro-optical panel driven by a driver, the electro-optical panel including: a transparent first substrate; a second substrate disposed so as to face the first substrate; a first segment electrode group arranged at the first substrate; a second segment electrode group arranged at the second substrate; a first common electrode group arranged at the second substrate and facing the first segment electrode group; a second common electrode group arranged at the first substrate and facing the second segment electrode group; a first panel-side terminal group coupled to the first segment electrode group and the first common electrode group; and a second panel-side terminal group coupled to the second segment electrode group and the second common electrode group, the driver including a first terminal group including a first segment terminal group configured to supply a segment driving signal to the first segment electrode group, and a first common terminal configured to supply a common driving signal to the first common electrode group, the first terminal group continuously arranged along a first side of the driver, and a second terminal group including a second segment terminal group configured to supply a segment driving signal to the second segment electrode group, and a second common terminal configured to supply a common driving signal to the second common electrode group, the second terminal group continuously arranged along the first side of the driver, the first panel-side terminal group coupled to the first terminal group, the second panel-side terminal group coupled to the second terminal group.

### BRIEF DESCRIPTION OF THE DRAWINGS

FIG. 1 is an exemplary configuration of an electro-optical device that does not use an embodiment of the present disclosure.

FIG. 2 is the exemplary configuration of the electro-optical device that does not use the embodiment of the present disclosure.

FIG. 3 is a plan view of an exemplary configuration of an electro-optical device according to the present embodiment.

FIG. 4 is a plan view of the exemplary configuration of the electro-optical device according to the present embodiment.

FIG. 5 is a cross-sectional view of the electro-optical device.

FIG. 6 illustrates overlapping between wiring regions.

FIG. 7 is a block diagram of an exemplary configuration of an electronic apparatus.

FIG. 8 shows a first detailed example of the arrangement of terminals of a driver.

FIG. 9 shows a second detailed example of the arrangement of the terminals of the driver.

FIG. 10 shows a third detailed example of the arrangement of the terminals of the driver.

FIG. 11 shows the third detailed example of the arrangement of the terminals of the driver.

FIG. 12 shows a fourth detailed example of the arrangement of the terminals of the driver.

FIG. 13 is a block diagram of a detailed exemplary configuration of the driver using the fourth detailed exemplary terminal arrangement.

FIG. 14 shows exemplary signal waveforms in static driving performed by a first segment driving circuit and a first common driving circuit.

FIG. 15 shows exemplary signal waveforms in duty driving performed by a second segment driving circuit and a second common driving circuit.

FIG. 16 shows a fifth detailed example of the arrangement of the terminals of the driver.

FIG. 17 is a block diagram of a detailed exemplary configuration of the driver using the fifth detailed exemplary terminal arrangement.

### DESCRIPTION OF EMBODIMENTS

A preferable embodiment of the present disclosure will be described below in detail. Note that the present embodiment described below unduly limits the contents described the in claims, and that all configurations described in the present embodiment are not necessarily essential configuration requirements.

### 1. Exemplary Configuration that Does Not Use Present Embodiment

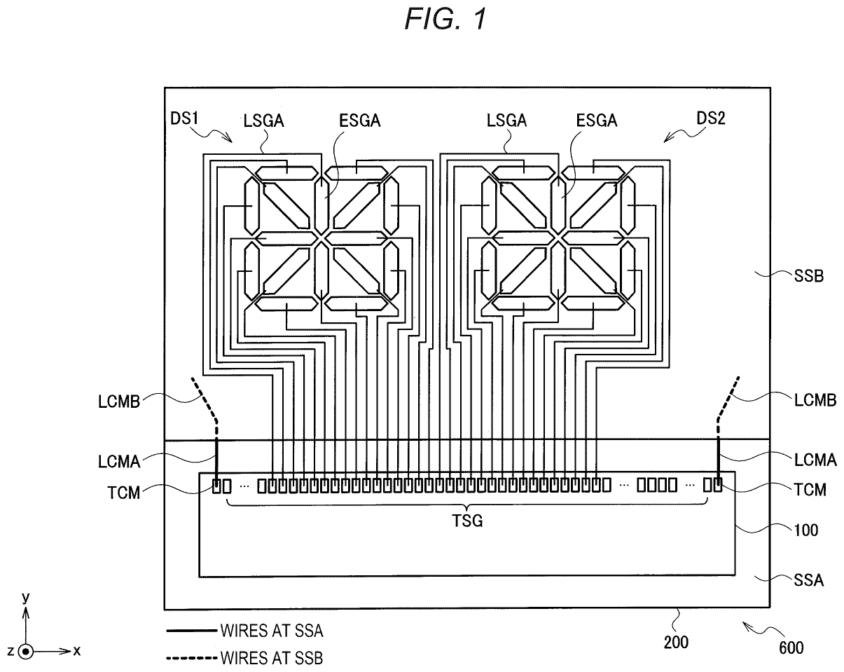

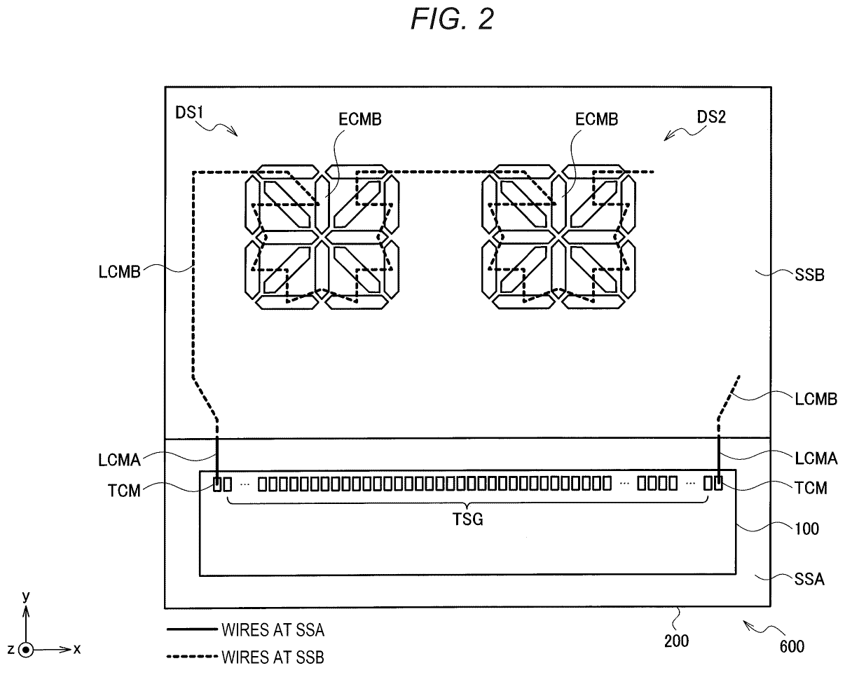

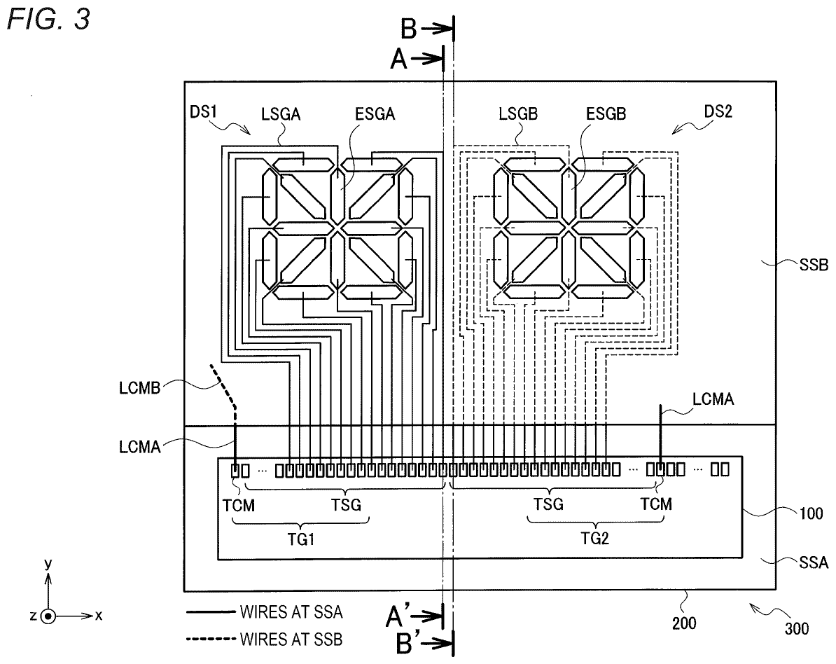

An electro-optical device according to the present embodiment will be described with reference to FIG. 3 and subsequent drawings. Before the description of the electro-optical device according to the present embodiment, an exemplary configuration that does not use the present embodiment and problems with the exemplary configuration will be described with reference to FIGS. 1 and 2. FIGS. 1 and 2 show an exemplary configuration of an electro-optical device 600, which does not use the present embodiment. The electro-optical device 600 includes a passive electro-optical panel 200 and a driver 100, which drives the electro-optical panel 200. It is assumed in the following description that the electro-optical panel 200 is a liquid crystal panel. FIGS. 1 and 2 are plan views of the electro-optical panel 200. FIG. 1 primarily shows segment electrodes and wires coupled thereto, and FIG. 2 primarily shows common electrodes and wires coupled thereto.

It is assumed that three directions orthogonal to each other are a first direction x, a second direction y, and a third direction z, as shown in FIGS. 1 and 2. The third direction z is a thickness direction of the electro-optical panel 200, and is the direction from a first substrate SSA toward a second substrate SSB, which will be described later. The first direction x and the second direction y are directions parallel to the planar surfaces of the electro-optical panel 200.

The electro-optical panel 200 includes the first substrate SSA, the second substrate SSB, a first electrode group DS1, a second electrode group DS2, segment wires LSGA, and common wires LCMA and LCMB. The first substrate SSA and the second substrate SSB are each a substrate made of a transparent material such as glass. The electrodes and the wires are each a thin film made of a transparent electrically conductive material such as ITO. ITO is an abbreviation for indium tin oxide. The first substrate SSA and the second substrate SSB are so arranged that the two substrates are parallel to each other in the order of SSA and SSB in the third direction z, that the two substrates face each other in such a way that three sides thereof coincide with each other in the plan view, and that the space between the two substrates is filled with a liquid crystal material.

The first electrode group DS1 includes multiple segment electrodes ESGA provided at a surface facing the second substrate SSB out of the two surfaces of the first substrate SSA, and multiple common electrodes ECMB provided at a surface facing the first substrate SSA out of the two surfaces of the second substrate SSB. The multiple segment electrodes ESGA contained in the first electrode group DS1 are called a first segment electrode group, and the multiple common electrodes ECMB contained in the first electrode group DS1 are called a first common electrode group. The common electrodes ECMB of the first common electrode group each face one of the segment electrodes ESGA of the first segment electrode group.

Similarly, the second electrode group DS2 includes multiple segment electrodes ESGA provided at a surface facing the second substrate SSB out of the two surfaces of the first substrate SSA, and multiple common electrodes ECMB provided at a surface facing the first substrate SSA out of the two surfaces of the second substrate SSB. The multiple segment electrodes ESGA contained in the second electrode group DS2 are called a second segment electrode group, and the multiple common electrodes ECMB contained in the second electrode group DS2 are called a second common electrode group. The common electrodes ECMB of the second common electrode group each face one of the segment electrodes ESGA of the second segment electrode group.

In the plan view of the electro-optical panel 200, the driver 100 has a rectangular shape having long sides in the first direction x, and is mounted on the first substrate SSA using by COG-mounting (chip-on-glass mounting) in a portion where the driver 100 does not overlap with the second substrate SSB. The driver 100 includes multiple terminals arranged along the long sides. The terminals at opposite ends out of the multiple terminals are common terminals TCM. Multiple segment terminals TSG are provided between the common terminals TCM at the opposite ends. Note that the first substrate SSA is provided with panel-side terminals coupled to the terminals of the driver 100. The wires on the substrate are coupled to the terminals of the driver 100 via the panel-side terminals. Note, however, that the wires on the substrate are simply described below as being coupled to the terminals of the driver 100.

In the portion where the second substrate SSB does not overlap with the first substrate SSA, the segment wires LSGA are provided at the first substrate SSA, and one-side ends of the segment wires LSGA are coupled to the segment terminals TSG of the driver 100, as shown in FIG. 1. Also in the portion where the first substrate SSA and the second substrate SSB overlap with each other, the segment wires LSGA are provided at the first substrate SSA, and the other-side ends of the segment wires LSGA are coupled to the segment electrodes ESGA provided at the first substrate SSA. The same arrangement and coupling described above are common to the first electrode group DS1 and the second electrode group DS2.

In the portion where the second substrate SSB does not overlap with the first substrate SSA, the common wires LCMA are provided at the first substrate SSA, and one-side ends of the common wires LCMA are coupled to the common terminals TCM of the driver 100, as shown in FIG. 2. The common wire LCMB is provided at the second substrate SSB in the portion where the first substrate SSA and the second substrate SSB overlap with each other. The other-side ends of the common wires LCMA at the first substrate SSA are coupled to the opposite ends of the common wire LCMB at the second substrate SSB via electrically conductive members provided between the first substrate SSA and the second substrate SSB. The common wire LCMB at the second substrate SSB is sequentially coupled to the common electrodes ECMB of the first electrode group DS1, and are sequentially coupled to the common electrodes ECMB of the second electrode group DS2.

In the exemplary configuration shown in FIGS. 1 and 2, all the segment electrodes ESGA are arranged at the first substrate SSA, and all the common electrodes ECMB are arranged at the second substrate SSB, as described above. Therefore, all the segment wires LSGA are routed on the first substrate SSA, and the greater the number of the segment electrodes ESGA, the wider the wiring region of the segment wires LSGA. When the number of displayed objects increases or the displayed objects become complicated, the number of the segment electrodes ESGA increases and the wiring region widens, but the segment electrodes ESGA cannot be arranged in the wiring region of the segment wires LSGA, resulting in a problem of limitation posed to the number of the segment electrodes ESGA that can be arranged or the degree of freedom of arrangement.

### 2. Exemplary Configuration in Present Embodiment

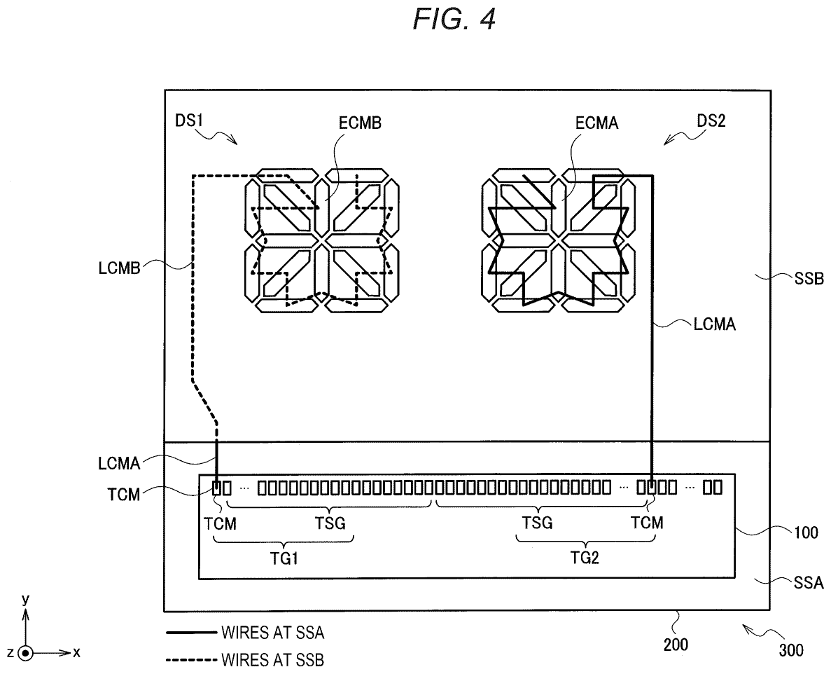

FIGS. 3 and 4 are plan views of an exemplary configuration of an electro-optical device 300 according to the present embodiment. The electro-optical device 300 includes a passive electro-optical panel 200 and a driver 100, which drives the electro-optical panel 200. The driver 100 is, for example, an integrated circuit device in which multiple circuit elements are integrated in a semiconductor substrate. It is assumed in the following description that the electro-optical panel 200 is a liquid crystal panel, but the electro-optical panel 200 may instead be an OLED panel, as will be described later. FIG. 3 primarily shows segment electrodes and wires coupled thereto, and FIG. 4 primarily shows common electrodes and wires coupled thereto. The definitions of the first direction x, the second direction y, and the third direction z are the same as those in the exemplary configuration shown in FIG. 1.

The electro-optical panel 200 includes a first substrate SSA, a second substrate SSB, a first electrode group DS1, a second electrode group DS2, segment wires LSGA and LSGB, and common wires LCMA and LCMB. The configurations of the substrates, the materials of the electrodes and the wires, and the configuration in which the space between the substrates is filled with the liquid crystal material are the same as those in the exemplary configuration shown in FIG. 1.

The first electrode group DS1 includes multiple segment electrodes ESGA provided at a surface facing the second substrate SSB out of the two surfaces of the first substrate SSA, and multiple common electrodes ECMB provided at a surface facing the first substrate SSA out of the two surfaces of the second substrate SSB. The multiple segment electrodes ESGA contained in the first electrode group DS1 are called a first segment electrode group, and the multiple common electrodes ECMB contained in the first electrode group DS1 are called a first common electrode group. The common electrodes ECMB of the first common electrode group each face one of the segment electrodes ESGA of the first segment electrode group.

Similarly, the second electrode group DS2 includes multiple segment electrodes ESGB provided at a surface facing the first substrate SSA out of the two surfaces of the second substrate SSB, and multiple common electrodes ECMA provided at a surface facing the second substrate SSB out of the two surfaces of the first substrate SSA. The multiple segment electrodes ESGB contained in the second electrode group DS2 are called a second segment electrode group, and the multiple common electrodes ECMA contained in the second electrode group DS2 are called a second common electrode group. The common electrodes ECMA of the second common electrode group each face one of the segment electrodes ESGB of the second segment electrode group.

The electrode groups are each, for example, an electrode group for selectively displaying, for example, multiple predetermined characters. For example, in the example shown in FIG. 1, the electrode groups can each display numbers, alphabets, symbols, or the like by combining electrodes to be turned on with each other. However, the electrode groups each do not need to be meaningful in the displayed form, and how a large number of electrodes arranged in the electro-optical panel may be allocated to each of the electrode groups in any manner.

The driver 100 includes multiple terminals, and outputs drive signals from the multiple terminals to the first electrode group DS1 and the second electrode group DS2 based on display data to cause the electro-optical panel 200 to display a display object corresponding to the display data. In the plan view of the electro-optical panel 200, the driver 100 has a rectangular shape having long sides in the first direction x, and is mounted on the first substrate SSA by using COG-mounting in a portion where the driver 100 does not overlap with the second substrate SSB. In the second direction y of the driver 100, the first substrate SSA and the second substrate SSB overlap with each other, and the first electrode group DS1 and the second electrode group DS2 are provided in the overlapping portion.

The multiple terminals of the driver 100 are arranged along a first side of the driver 100. The first side may be any side of the driver 100. FIGS. 3 and 4 show a case where multiple terminals are arranged along a long side facing the portion where the first substrate SSA and the second substrate SSB overlap with each other. Note, however, that another set of terminals may be arranged along the other long side, or that terminals may be arranged along not only the long side but also a short side. The sentence “multiple terminals are arranged along a side” means that the multiple terminals are arranged in a portion of the driver 100 that is close to the side in the direction parallel to the side. For example, when one of the two long sides is considered, the state in which a portion that is close to a side means that the terminals are closer to the one long side than the other long side. As an example, the state in which the terminals are close to a side means a state in which the terminals are near the side, for example, a state in which there is no circuit element between the side and the terminals.

The multiple terminals of the driver 100 include a first terminal group TG1 and a second terminal group TG2 adjacent to each other along the first side. The driver 100 may include three or more terminal groups, but the following description will be made with reference to a case where the driver includes two terminal groups. The state in which two terminal groups are adjacent to each other means that there is no other terminal between the two terminal groups, but not necessarily as long as neither a segment terminal nor a common terminal is disposed between the two terminal groups, and the presence of a monitor terminal, a test terminal, or any other terminal between the two terminal groups is not excluded.

The first terminal group TG1 and the second terminal group TG2 each include multiple segment terminals TSG continuously arranged along the first side, and a common terminal TCM. FIGS. 3 and 4 show a case where one terminal group includes one common terminal, but in the case of duty driving, one terminal group may include multiple common terminals. The state in which a terminal group is continuously arranged along a side means that multiple terminals are arranged adjacent to each other along the side, but the presence of a monitor terminal, a test terminal, or any other terminal between some terminals out of a large number of terminals is not excluded. The multiple segment terminals and the common terminal contained in the first terminal group TG1 are called a first segment terminal group and a first common terminal, respectively. The multiple segment terminals and the common terminal contained in the second terminal group TG2 are called a second segment terminal group and a second common terminal, respectively. Note that the first substrate SSA is provided with panel-side terminals coupled to the terminals of the driver 100. A panel-side terminal group coupled to the first terminal group TG1 of the driver 100 is called a first panel-side terminal group, and a panel-side terminal group coupled to the second terminal group TG2 of the driver 100 is called a second panel-side terminal group. The wires on the substrate are coupled to the terminals of the driver 100 via the panel-side terminals. Note, however, that the wires on the substrate are simply described below as being coupled to the terminals of the driver 100.

In the portion where the second substrate SSB does not overlap with the first substrate SSA, the segment wires LSGA are provided at the first substrate SSA, and one-side ends of the segment wires LSGA are coupled to the segment terminals TSG of the first terminal group TG1 and the second terminal group TG2, as shown in FIG. 3. In the portion where the first substrate SSA and the second substrate SSB overlap with each other, the segment wires LSGA coupled to the segment terminals TSG of the first terminal group TG1 are routed on the first substrate SSA, and the other-side ends of the segment wires LSGA are coupled to the segment electrodes ESGA of the first electrode group DS1. The other-side ends of the segment wires LSGA coupled to the segment terminals TSG of the second terminal group TG2 are coupled to one-side ends of the segment wires LSGB provided at the second substrate SSB via electrically conductive members provided between the first substrate SSA and the second substrate SSB. The segment wires LSGB are routed on the second substrate SSB, and the other-side ends of the segment wires LSGB are coupled to the segment electrodes ESGB of the second electrode group DS2. The segment wires LSGA coupled to the segment electrodes ESGA of the first electrode group DS1, that is, the first segment electrode group are called a first segment wire group. The segment wires LSGB coupled to the segment electrodes ESGB of the second electrode group DS2, that is, the second segment electrode group are called a second segment wiring group.

In the portion where the second substrate SSB does not overlap with the first substrate SSA, the common wires LCMA are provided at the first substrate SSA, one end of one of the common wires LCMA is coupled to the common terminal TCM of the first terminal group TG1, and one end of the other common wire LCMA is coupled to the common terminal TCM of the second terminal group TG2, as shown in FIG. 4. In the portion where the first substrate SSA and the second substrate SSB overlap with each other, the common wire LCMA coupled to the common terminal TCM of the first terminal group TG1 is coupled to one end of the common wire LCMB provided at the second substrate SSB via an electrically conductive member provided between the first substrate SSA and the second substrate SSB. The common wire LCMB is routed on the second substrate SSB and sequentially coupled to the common electrodes ECMB of the first electrode group DS1. The common wire LCMA coupled to the common terminal TCM of the second terminal group TG2 is routed on the first substrate SSA and sequentially coupled to the common electrodes ECMA of the second electrode group DS2. The common wire LCMB coupled to the common electrodes ECMB of the first electrode group DS1, that is, the first common electrode group is called a first common wire. The common wire LCMA coupled to the common electrodes ECMA of the second electrode group DS2, that is, the second common electrode group is called a second common wire.

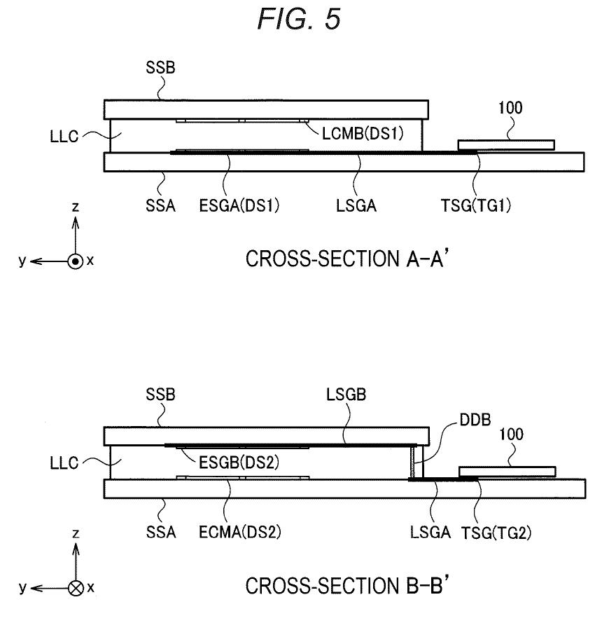

FIG. 5 is a cross-sectional view of the electro-optical device 300. FIG. 5 includes a cross-sectional view taken along the line AA′ shown in FIG. 3 and a cross-sectional view taken along the line BB′ shown in FIG. 3. Although the plane of each of the cross-sectional views does not pass through any of the electrodes, the AA′ cross-sectional view shows an electrode viewed in the −x direction, and the BB′ cross-sectional view shows an electrode viewed in the +x direction. In the following description, the +z direction is also called an upward direction, and the −z direction is also called a downward direction.

The driver 100 is mounted on the upper surface of the first substrate SSA, and the space between the upper surface of the first substrate SSA and the lower surface of the second substrate SSB is filled with a liquid crystal material, as shown in FIG. 5. The segment terminals TSG of the first terminal group TG1 are coupled to the segment wires LSGA provided on the upper surface of the first substrate SSA, as shown in the AA′ cross-sectional view. The segment wires LSGA are coupled to the segment electrodes ESGA of the first electrode group DS1, which are provided at the upper surface of the first substrate SSA. The common electrodes ECMB of the first electrode group DS1 are provided at the lower surface of the second substrate SSB so as to face the segment electrodes ESGA. The segment terminals TSG of the second terminal group TG2 are coupled to the segment wires LSGA provided at the upper surface of the first substrate SSA, as shown in the BB′ cross-sectional view. The segment wires LSGA are coupled to the segment wires LSGB provided at the lower surface of the second substrate SSB via electrically continuous members DDB. The segment wires LSGA are coupled to the segment electrodes ESGB of the second electrode group DS2 provided at the lower surface of the second substrate SSB. The common electrodes ECMA of the second electrode group DS2 are provided at the upper surface of the first substrate SSA so as to face the segment electrodes ESGB.

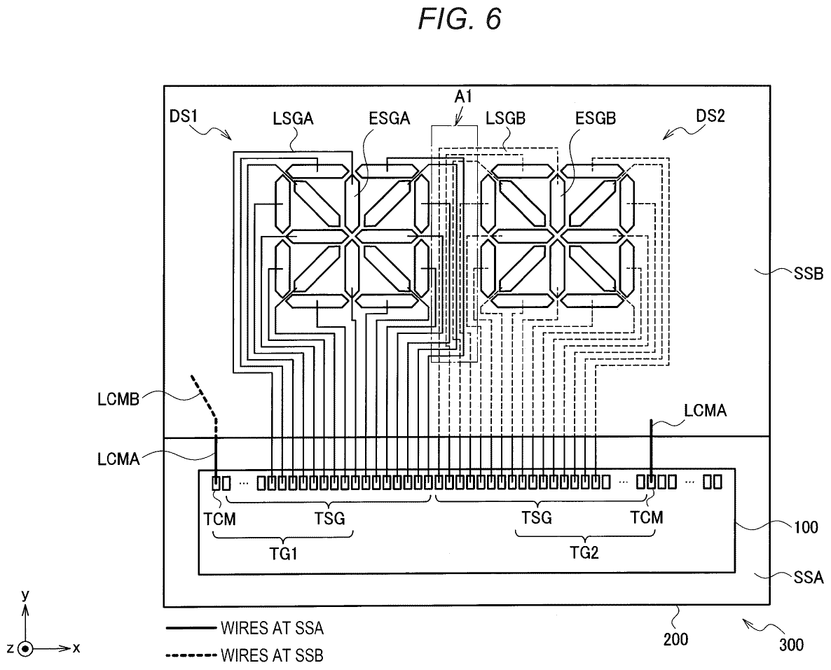

As described above, in the exemplary configuration shown in FIGS. 3 to 5, the segment electrodes ESGA of the first electrode group DSI are arranged at the first substrate SSA, and the segment electrodes ESGB of the second electrode group DS2 are arranged at the second substrate SSB. Therefore, the segment wires LSGA coupled to the segment electrodes ESGA of the first electrode group DS1 are routed on the first substrate SSA, and the segment wires LSGB coupled to the segment electrodes ESGB of the second electrode group DS2 are routed on the second substrate SSB. The wiring region of the segment wires LSGA at the first substrate SSA and the wiring region of the segment wires LSGB at the second substrate SSB can be arranged so as to overlap with each other in the plan view, as shown in a region A1 of FIG. 6.

The ratio of the wiring regions to the entire electro-optical panel 200 can therefore be reduced as compared with the configuration shown in FIGS. 1 and 2. The reduction in the proportion of the wiring regions can increase the number of electrodes that can be arranged in the electro-optical panel 200, the proportion of the region where the electrodes are arranged, the degree of freedom of the electrode arrangement, or the like. For example, since the wiring region between the first electrode group DS1 and the second electrode group DS2 can be reduced as shown in FIG. 6, the interval between displayed objects such as characters can be reduced to improve the degree of freedom of display design. Furthermore, the arrangement of the terminals coupled to the segment electrodes arranged at the first substrate and the terminals coupled to the segment electrodes arranged at the second substrate can be optimized, so that the wiring on the electro-optical panel 200 is readily performed. Moreover, since the common terminal is provided in each of the terminal groups, the common wiring can also be optimized so that the wiring is readily performed as compared with the case where the common terminals are provided only at opposite ends of the terminal row as shown in FIGS. 1 and 2. Furthermore, since the degree of freedom of the electrode arrangement and wiring easiness are improved, a driver of a single model can be used with panels having various types of design (segment electrode arrangement).

The case where the electro-optical panel 200 is a liquid crystal panel has been described with reference to FIGS. 3 to 5, but note that the electro-optical panel 200 may be an OLED panel. OLED is an abbreviation for organic light emitting diode. In this case, one of the first substrate SSA and the second substrate SSB may be an opaque substrate. An OLED layer is provided between the first substrate SSA and the second substrate SSB. The driver 100 causes the OLED layer, which is the portion sandwiched between the segment electrodes and the common electrodes, to emit light by causing a drive current to flow in the portion between the segment electrodes and the common electrodes facing the segment electrodes.

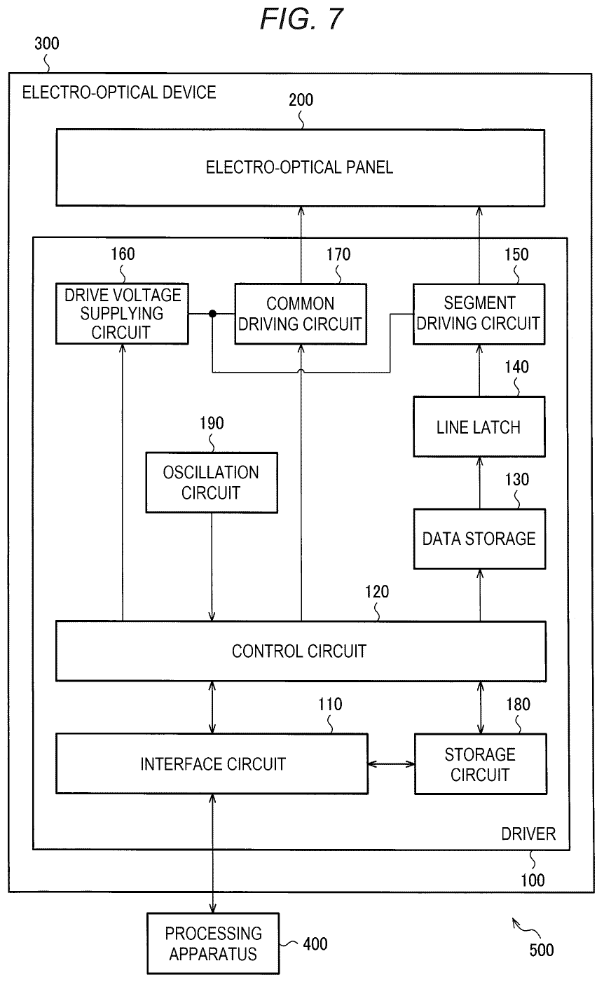

FIG. 7 is a block diagram of an exemplary configuration of an electronic apparatus 500. The electronic apparatus 500 includes the electro-optical device 300 and a processing device 400. The electro-optical device 300 includes the electro-optical panel 200 and the driver 100. A cluster panel incorporated in a vehicle or a display provided in a home electronic apparatus can, for example, be assumed as the electro-optical device 300 or the electronic apparatus 500. The vehicle may include a two-wheeled vehicle, an automobile, a ship, an airplane, a robot, or the like. The cluster panel and the display are each a panel that displays information such as icons, numbers, characters, or meters. However, the applications of the electro-optical device 300 and the electronic apparatus 500 are not limited to those described above.

The driver 100 includes an interface circuit 110, a control circuit 120, a data storage 130, a line latch 140, a segment driving circuit 150, a driving voltage supplying circuit 160, a common driving circuit 170, a storage circuit 180, and an oscillation circuit 190.

The interface circuit 110 performs communication between the driver 100 and the processing device 400. Specifically, the interface circuit 110 receives display data used to control the display of each of the segment electrodes from the processing device 400. For example, in static driving, the display data is data used to activate or deactivate the display of each of the segment electrodes. Instead, in duty driving or in static driving but in PWM driving, the display data is data used to set the grayscale of the display of the segment electrodes. For example, a serial interface method such as an inter-integrated-circuit (I2C) method or a serial peripheral interface (SPI) method can be employed as a method in accordance with which the interface circuit 110 performs the communication. A parallel interface method may instead be employed as the method in accordance with which the interface circuit 110 performs the communication. The interface circuit 110 may include an input and output buffer circuit and a control circuit that realize the communication methods described above. The processing device 400 is a host device of the driver 100, for example, a processor or a display controller. The processor is, for example, a CPU or a microcomputer.

The storage circuit 180 stores setting information used to set the operation of the driver 100. The setting information includes, for example, information used to set each of the terminal groups to be operated by static driving or duty driving, or information used to set a predetermined terminal switchable to a segment terminal or a common terminal to the segment terminal or the common terminal. A configuration capable of switching any of the terminal groups or the terminals to another will be described later. The storage circuit 180 is a register, a volatile memory, a nonvolatile memory, or the like. The volatile memory is an SRAM, a DRAM, or the like. The nonvolatile memory is an OTP memory, an EEPROM, or the like. For example, the processing device 400 may write the setting information into the register or the volatile memory via the interface circuit 110. The setting information may instead be written into the nonvolatile memory at the time of manufacturing the driver 100, the electro-optical device 300, or the electronic apparatus 500.

The control circuit 120 is a logic circuit and operates based on a clock signal input from the oscillation circuit 190. The control circuit 120 controls a drive timing at which the driver 100 starts driving the electro-optical panel 200. Specifically, the control circuit 120 causes the data storage 130 to store the display data. In each frame, the control circuit 120 controls the segment driving circuit 150 to cause it to output a drive signal corresponding to the display data in the frame. The control circuit 120 performs drive polarity inversion control on a frame basis.

The data storage 130 stores the display data from the control circuit 120. The data storage 130 is a semiconductor memory, and is what is called a display data RAM. The data storage 130 may instead be a register. The line latch 140 latches drive data corresponding to one frame and read from the data storage 130.

The driving voltage supplying circuit 160 generates a driving voltage used to generate a segment driving signal and a common driving signal, and supplies the generated driving voltage to the segment driving circuit 150 and the common driving circuit 170. The driving voltage supplying circuit 160 includes, for example, a regulator that regulates a power supply voltage for the driver 100 to generate a regulated voltage, and a voltage dividing circuit that divides the regulated voltage to generate the driving voltage.

The segment driving circuit 150 outputs a signal to transparent electrodes for the segments of the electro-optical panel 200 based on the drive data latched by the line latch 140. That is, the segment driving circuit 150 drives the segment electrodes by outputting, from a segment terminal, the segment driving signal having the driving voltage corresponding to the display data. A segment electrode driving method may be any of various methods such as static driving, PWM driving, or duty driving.

The common driving circuit 170 drives the common electrodes of the electro-optical panel 200. That is, the common driving circuit 170 drives the common electrodes by outputting, from a common terminal, the common driving signal having the driving voltage corresponding to the polarity.

In the following description, parentheses may indicate correspondence between a term and an example. For example, the “first segment electrode group (ESGA of DS1)” means that the segment electrodes ESGA of the first electrode group DS1 shown in FIG. 3 correspond to the “first segment electrode group”.

In the present embodiment, the electro-optical device 300 includes the electro-optical panel 200 and the driver 100, which drives the electro-optical panel 200. The electro-optical panel 200 includes the transparent first substrate SSA, the second substrate SSB disposed so as to face the first substrate SSA, the first segment electrode group (ESGA of DS1) arranged at the first substrate SSA, and the second t electrode group (ESGB of DS2) arranged at the second substrate SSB. The electro-optical panel 200 further includes the first common electrode group (ECMB of DS1) arranged at the second substrate SSB and facing the first segment electrode group, and the second common electrode group (ECMA of DS2) arranged at the first substrate SSA and facing the second segment electrode group. The driver 100 includes the first terminal group TG1 continuously arranged along a first side HN1 of the driver 100 and the second terminal group TG2 continuously arranged along the first side HN1 of the driver 100. The first terminal group TG1 includes the first segment terminal group (TSG of TG1), which supplies the segment driving signal to the first segment electrode group, and the first common terminal (TCM of TG1), which supplies the common driving signal to the first common electrode group. The second terminal group TG2 includes the second segment terminal group (TSG of TG2), which supplies the segment driving signal to the second segment electrode group, and the second common terminal (TCM of TG2), which supplies the common driving signal to the second common electrode group.

According to the present embodiment, the first segment electrode group is arranged at the first substrate SSA, and the second segment electrode group is arranged at the second substrate SSB. A set of a common terminal and a segment terminal group is provided not only at each of the opposite ends of the driver 100 but also in each of the terminal groups. The configuration described above allows efficient wiring in the electro-optical panel 200, and can increase the number of electrodes that can be arranged in the electro-optical panel 200, the proportion of the region where the electrodes are arranged, the degree of freedom of the electrode arrangement, or the like. Specifically, the wiring regions are allowed to overlap with each other, so that the interval between display objects such as characters can be reduced to improve the degree of freedom of display design, as described with reference to FIG. 6. Furthermore, the arrangement of the terminals coupled to the segment electrodes arranged at the first substrate and the terminals coupled to the segment electrodes arranged at the second substrate can be optimized, so that the wiring on the electro-optical panel 200 is readily performed. Moreover, since a common terminal is provided in each of the terminal groups, the common wiring can also be optimized, so that the wiring is readily performed. Furthermore, since the degree of freedom of the electrode arrangement and wiring easiness are improved, a driver of a single model can be used with panels having various types of design (segment electrode arrangement).

In the present embodiment, the electro-optical panel 200 further includes the first segment wire group (LSGA coupled to ESGA of DS1), which is arranged at the first substrate SSA and couples the first segment electrode group (ESGA of DS1) to the first segment terminal group (TSG of TG1). The electro-optical panel 200 further includes the second segment wire group (LSGB coupled to ESGB of DS2), which is arranged at the second substrate SSB and couples the second segment electrode group (ESGB of DS2) to the second segment terminal group (TSG of TG2).

According to the present embodiment, the first segment wire group is arranged at the first substrate SSA, and the second segment wire group is arranged at the second substrate SSB. The efficient wiring described above is thus achieved, so that various advantages are provided, such as increases in the number of electrodes that can be arranged in the electro-optical panel 200, the proportion of the region where the electrodes are arranged, or the degree of freedom of the electrode arrangement.

In addition, in the plan view of the electro-optical panel 200, the region where the first segment wire group is arranged and the region where the second segment wire group is arranged may at least partially overlap with each other (A1), as described with reference to FIG. 6.

According to the present embodiment, the area occupied by the regions where the segment wires are arranged in the electro-optical panel 200 is reduced. Various advantages are therefore provided, such as increases in the number of electrodes that can be arranged in the electro-optical panel 200, the proportion of the region where the electrodes are arranged, or the degree of freedom of the electrode arrangement.

In the present embodiment, the electro-optical panel 200 may include a third segment electrode group arranged at one of the first substrate SSA and the second substrate SSB, and a third common electrode group arranged at the other one of the first substrate SSA and the second substrate SSB and facing the third segment electrode group. The driver 100 may include a third terminal group continuously arranged along the first side HN1 of the driver 100. The third terminal group may include a third segment terminal group that supplies the segment drive signal to the third segment electrode group, and a third common terminal that supplies the common drive signal to the third common electrode group.

As described above, since multiple terminal groups are provided in the driver 100 and a common terminal and a segment terminal group are provided in each of the terminal groups, the terminal groups can be coupled to the electrode groups each including a segment electrode group and a common electrode group arranged so as to face the segment electrode group. The segment wires and the common wires can therefore be optimized, so that various advantages, such as support for the various types of panel design described above, are provided.

### 3. Detailed Examples of Terminal Arrangement

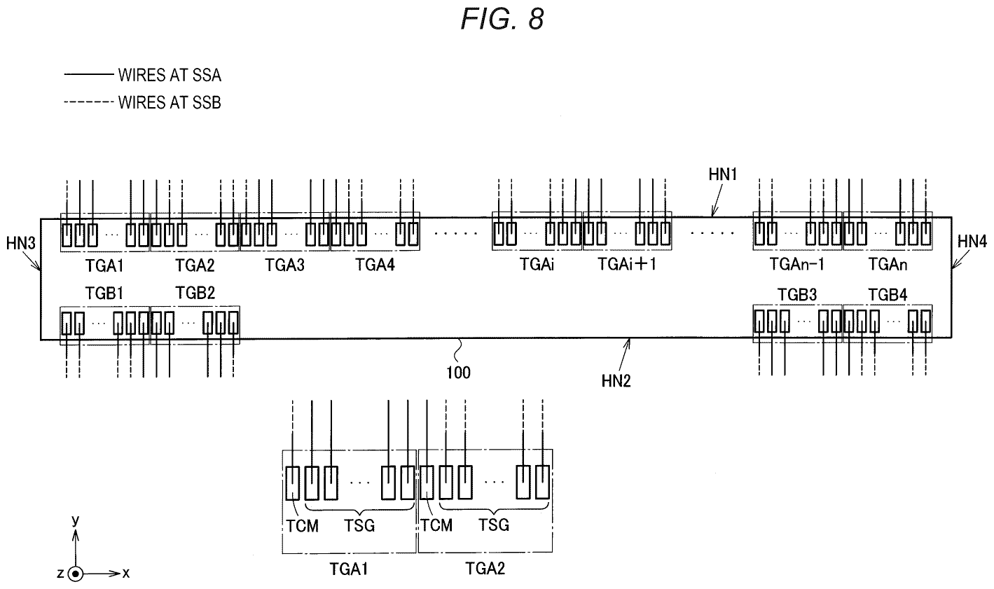

FIG. 8 shows a first detailed example of the arrangement of the terminals of the driver 100. In the following description, the electro-optical panel 200 is not shown, but a wire coupled to a terminal is indicated by a solid line or a dotted line to indicate at which substrate the wire is disposed. The solid lines indicate wires arranged at the first substrate SSA, and the dotted lines indicate wires arranged at the second substrate SSB. When the line extending from a terminal is only a solid line, the wire expressed by the solid line is coupled to an electrode disposed at the first substrate SSA. When the line extending from a terminal changes from a solid line to a dotted line, the wire expressed by the solid and dotted lines is coupled to an electrode disposed at the second substrate SSB.

The driver 100 has the first side HN1, which is a long side, a second side HN2, which is a long side facing the first side HN1, a third side HN3, which is a short side perpendicular to the first side HN1 and the second side HN2, and a fourth side HN4, which is a short side facing the third side HN3. The driver 100 includes terminal groups TGA1 to TGAn arranged along the first side HN1. The symbol n is an integer greater than or equal to two. In FIG. 8, i is an integer greater than or equal to one but smaller than or equal to n−1. The terminal groups TGA1 to TGAn are arranged adjacent to each other in this order. The driver 100 further includes terminal groups TGB1 to TGB4 arranged along the second side HN2. The terminal groups TGB1 and TGB2 are arranged adjacent to each other in a portion facing the third side HN3, and the terminal groups TGB3 and TGB4 are arranged adjacent to each other in a portion facing the fourth side HN4. Note that the number of the terminal groups arranged along the second side HN2 is not limited to four, or that no terminal groups may be arranged along the second side HN2.

FIG. 8 shows terminals contained in each of the terminal groups, the terminal groups TGA1 and TGA2 by way of example. The terminal groups TGA1 and TGA2 each include a common terminal TCM and multiple segment terminals TSG. In each of the terminal groups, the common terminal TCM and the multiple segment terminals TSG are arranged in this order along the first direction x. Note that in each of the terminal groups, the multiple segment terminals TSG and the common terminal TCM may be arranged in this order along the first direction x. In the terminal group TGA1, the segment terminals TSG are coupled to the segment electrodes ESGA at the first substrate SSA, and the common terminal TCM is coupled to the common electrodes ECMB at the second substrate SSB. In the terminal group TGA2, the segment terminals TSG are coupled to the segment electrodes ESGB at the second substrate SSB, and the common terminal TCM is coupled to the common electrodes ECMA at the first substrate SSA. The same holds true for the terminal groups TGA3 to TGAn and TGB1 to TGB4, which follow the terminal groups TGA1 and TGA2.

Note in FIG. 8 that any two adjacent terminal groups out of the terminal groups TGA1 to TGAn, the terminal groups TGB1 and TGB2, or the terminal groups TGB3 and TGB4 correspond to the first and second terminal groups described with reference to FIGS. 3 to 5.

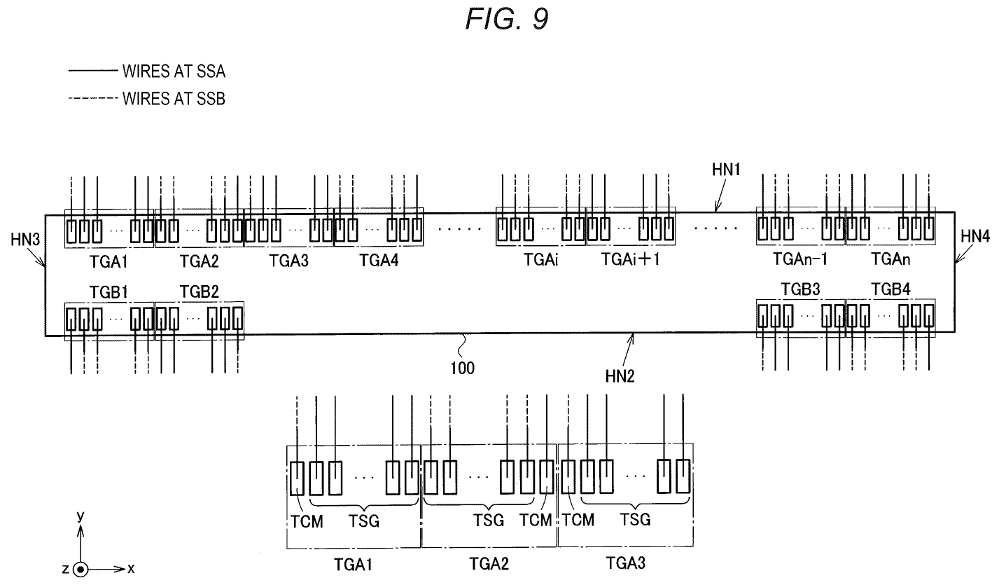

FIG. 9 is a second detailed example of the arrangement of the terminals of the driver 100. The arrangement of the terminal groups TGA1 to TGAn and TGB1 to TGB4 is the same as that in FIG. 8, but in this exemplary configuration, the order in accordance with which the common terminal and the segment terminals are arranged in each of the terminal groups differs from that in FIG. 8. Note that the number of the terminal groups arranged along the second side HN2 is not limited to four, or that no terminal groups may be arranged along the second side HN2.

FIG. 9 shows terminals contained in each of the terminal groups, the terminal groups TGA1 to TGA3 by way of example. In the terminal group TGA1, the common terminal TCM and the multiple segment terminals TSG are arranged in this order along the first direction x. In the terminal group TGA2, the multiple segment terminals TSG and the common terminal TCM are arranged in this order along the first direction x. In the terminal group TGA3, the common terminal TCM and the multiple segment terminals TSG are arranged in this order along the first direction x. That is, the segment terminals TSG are adjacent to each other between the terminal groups TGA1 and TGA2, and the common terminals TCM are adjacent to each other between the terminal groups TGA2 and TGA3. The same holds true for the terminal groups TGA4 to TGAn, which follow the terminal groups TGA1 to TGA3.

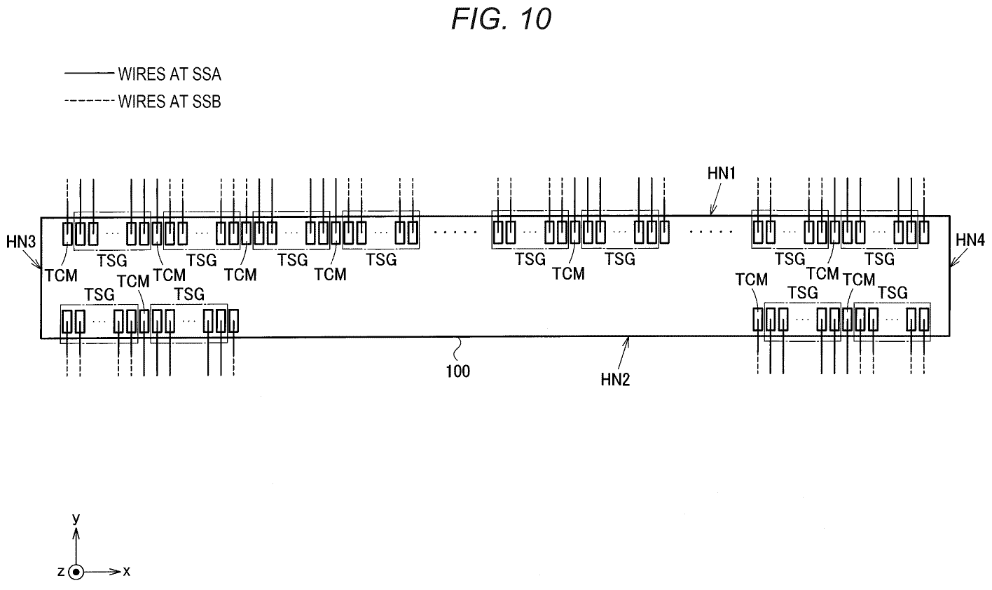

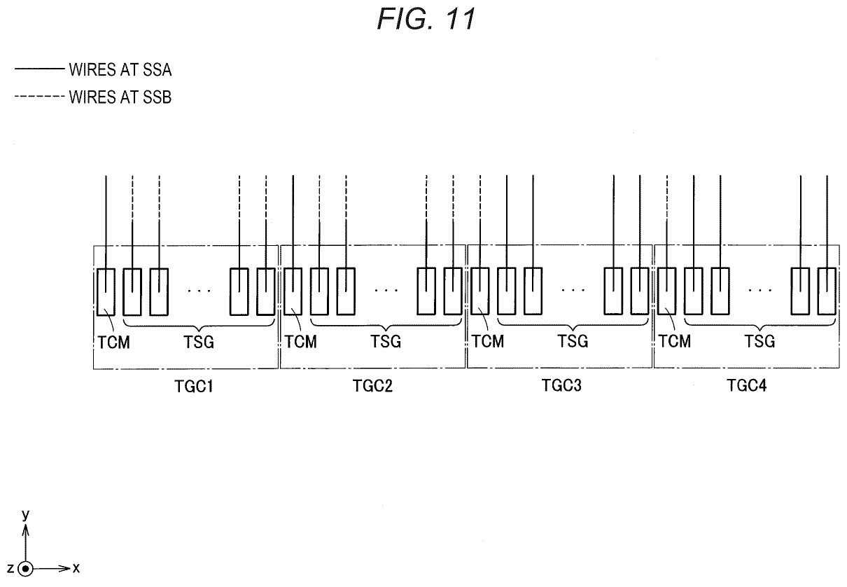

FIGS. 10 and 11 show a third detailed example in which the terminals of the driver 100 are arranged. The common terminal TCM and the multiple segment terminals TSG are alternately arranged along the first side HN1 and the second side HN2 in the same manner as in FIG. 8, but the common terminals TCM may each be coupled to any substrate in this exemplary configuration. In FIG. 10, a solid line is coupled to each of the common terminals TCM, and neither a solid line nor a dotted line is coupled to the solid line. This indicates that a common electrode to which each of the common terminals TCM is coupled may be disposed at either the first substrate SSA or the second substrate SSB.

FIG. 11 shows an example how the terminals are coupled in each of the terminal groups, four sets of the common terminal TCM and the multiple segment terminals TSG by way of example. It is assumed that the sets of the common terminal TCM and the multiple segment terminals TSG are terminal groups TGC1, TGC2, TGC3, and TGC4 sequentially along the first direction x, as shown in FIG. 11. The four terminal groups are any four terminal groups continuously arranged along the first direction x in FIG. 10.

In the terminal group TGC2, the common terminal TCM is coupled to the common electrodes ECMA arranged at the first substrate SSA, and the segment terminals TSG are coupled to the segment electrodes ESGB arranged at the second substrate SSB. In the terminal group TGC3, the common terminal TCM is coupled to the common electrodes ECMB arranged at the second substrate SSB, and the segment terminals TSG are coupled to the segment electrodes ESGA arranged at the first substrate SSA. The two adjacent terminal groups TGC2 and TGC3 correspond to the first and second terminal groups described with reference to FIGS. 3 to 5. As described above, at least one set of adjacent terminal groups in which the terminal-substrate coupling relationship is reversed may suffice, and the other terminal groups may each have any coupling relationship. For example, the terminal group TGC1 adjacent to the terminal group TGC2 may have the same terminal-substrate coupling relationship as the terminal group TGC2, and the terminal group TGC4 adjacent to the terminal group TGC3 may have the same terminal-substrate coupling relationship as the terminal group TGC3, as shown in FIG. 11.

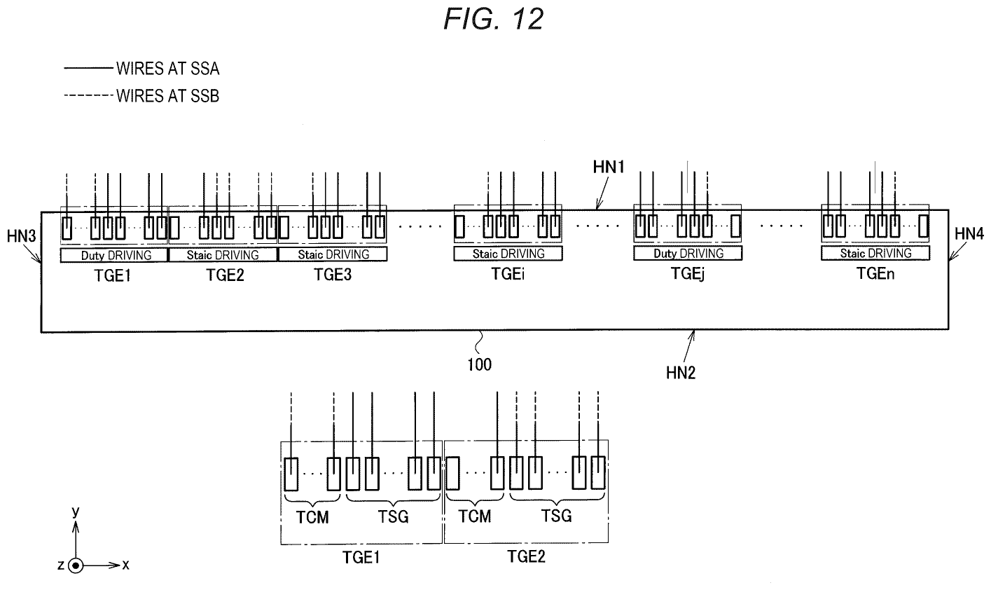

FIG. 12 is a fourth detailed example of the arrangement of the terminals of the driver 100. The driver 100 includes terminal groups TGE1 to TGEn arranged along the first side HN1. In the drawing, j is an integer greater than i but smaller than or equal to n. The terminal groups TGE1 to TGEn are arranged adjacent to each other in this order. Note that similar terminal groups may be arranged along the second side HN2.

The terminal groups TGE1 to TGEn may operate in static driving or duty driving in a switchable manner therebetween. Instead, the terminal groups TGE1 to TGEn may operate in a fixed driving method, static driving or duty driving.

FIG. 12 shows terminals contained in each of the terminal groups, the TGE1 and TGE2 by way of example. The terminal groups each include multiple common terminals TCM and multiple segment terminals TSG arranged along the first direction x. Note that the multiple segment terminals TSG and the multiple common terminals TCM may be sequentially arranged in this order along the first direction x. The number of the multiple common terminals TCM is a number corresponding to the duty ratio of duty driving. For example, in a case of ½ duty driving or ¼ duty driving, two or more common terminals TCM or four or more common terminals TCM may be provided, respectively. FIG. 12 shows a case where the terminal group TGE1 is set to operate in duty driving and the terminal group TGE2 is set to operate in static driving. The multiple common terminals TCM of the terminal group TGE1 are coupled to the common electrodes ECMB provided at the second substrate SSB, and the multiple segment terminals TSG of the terminal group TGE1 are coupled to the segment electrodes ESGA provided at the first substrate SSA. One of the multiple common terminals TCM of the terminal group TGE2 is coupled to the common electrodes ECMA provided at the first substrate SSA, and the multiple segment terminals TSG of the terminal group TGE2 are coupled to the segment electrodes ESGB provided at the second substrate SSB. Note that the terminal group TGE1 may be set to operate in static driving and the terminal group TGE2 may be set to operate in duty driving, and the terminal-substrate coupling relationship in each of the terminal groups may be opposite to the above.

Note that any two adjacent terminal groups in FIG. 12 correspond to the first and second terminal groups described with reference to FIGS. 3 to 5. Both the first and second terminal groups may be set to operate in static driving or duty driving, or one of the first and second terminal groups may be set to operate in static driving and the other may be set to operate in duty driving.

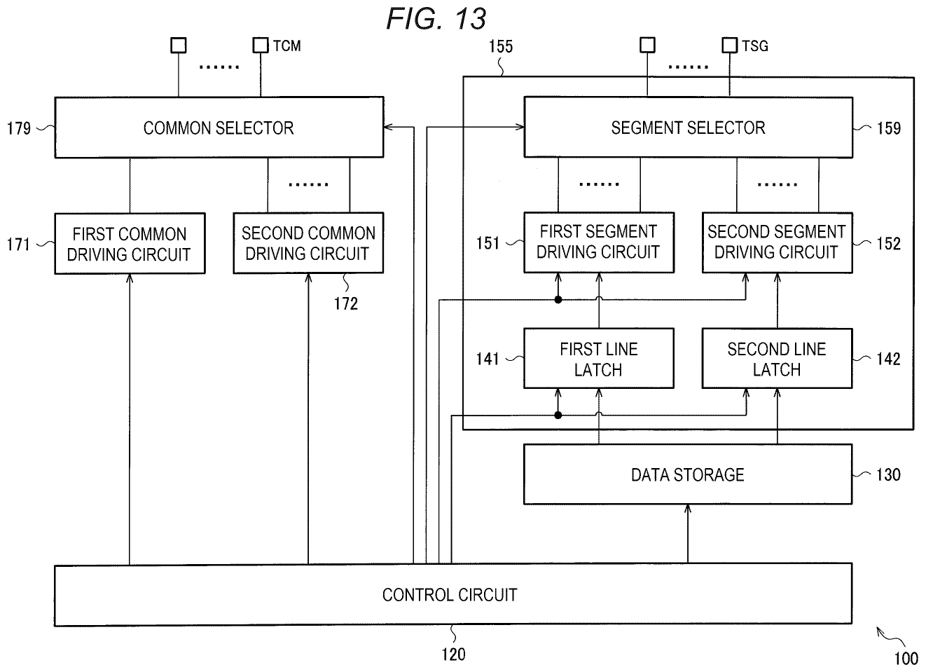

FIG. 13 is a block diagram of a detailed exemplary configuration of the driver 100 using the exemplary terminal arrangement shown in FIG. 12. The driver 100 includes a common selector 179, a first common driving circuit 171, a second common driving circuit 172, a driving circuit 155, the data storage 130, and the control circuit 120. Note that FIG. 13 shows a configuration corresponding to one terminal group. In FIG. 13, the driving voltage supplying circuit 160, the oscillation circuit 190, the interface circuit 110, and the storage circuit 180 are not shown.

The first common driving circuit 171 outputs a common driving signal for static driving based on a timing control signal from the control circuit 120. Based on the timing control signal from the control circuit 120, the second common driving circuit 172 outputs a common driving signal for duty driving by the number of signals according to the duty ratio. The timing control signal is, for example, a frame signal indicating a frame or a subfield signal indicating a subfield in each frame.

The common selector 179 outputs the common driving signal for static driving to one common terminal TCM when the control signal from the control circuit 120 indicates static driving, and outputs the common driving signal for duty drive to the multiple common terminals TCM when the control signal indicates duty driving. The common selector 179 is, for example, an analog switch circuit using a transistor.

The data storage 130 stores display data for static driving or display data for duty driving from the control circuit 120.

The driving circuit 155 outputs a segment driving signal for static driving or a segment drive signal for duty driving to the segment terminals TSG. Specifically, the driving circuit 155 includes a segment selector 159, a first segment driving circuit 151, a second segment driving circuit 152, a first line latch 141, and a second line latch 142.

The first line latch 141 latches the display data for static driving based on a latch signal from the control circuit 120. When a polarity signal from the control circuit 120 indicates the positive polarity, the first segment driving circuit 151 does not logically invert the display data latched by the first line latch 141, converts the display data not having been logically inverted into a voltage, and outputs the voltage as the segment driving signal for static driving. When the polarity signal indicates the negative polarity, the first segment driving circuit 151 logically inverts the display data latched by the first line latch 141, converts the display data having been logically inverted into a voltage, and outputs the voltage as the segment driving signal for static driving. The first segment driving circuit 151 performs the logic inversion and the signal output described above based on the timing control signal from the control circuit 120. The timing control signal is, for example, the frame signal.

The second line latch 142 latches the display data for duty driving based on the latch signal from the control circuit 120. The second segment driving circuit 152 converts the display data latched by the second line latch 142 into a segment driving signal according to the grayscale of the display data, and outputs the segment driving signal as the segment driving signal for duty driving. The second segment driving circuit 152 performs the signal output described above based on the timing control signal from the control circuit 120. The timing control signal is, for example, the frame signal or the subfield signal.

The segment selector 159 outputs the segment driving signal for static driving to the segment terminals TSG when the control signal from the control circuit 120 indicates static drive, and outputs the segment driving signal for duty drive to the segment terminals TSG when the control signal indicates duty driving. The segment selector 159 is, for example, an analog switch circuit using a transistor.

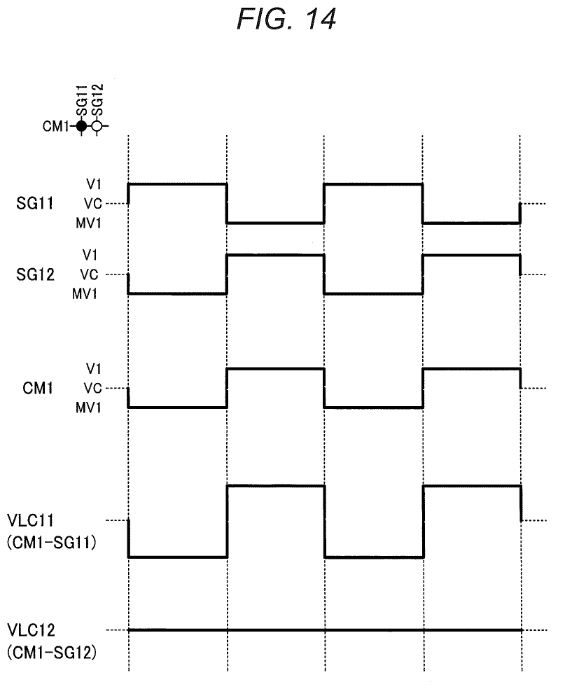

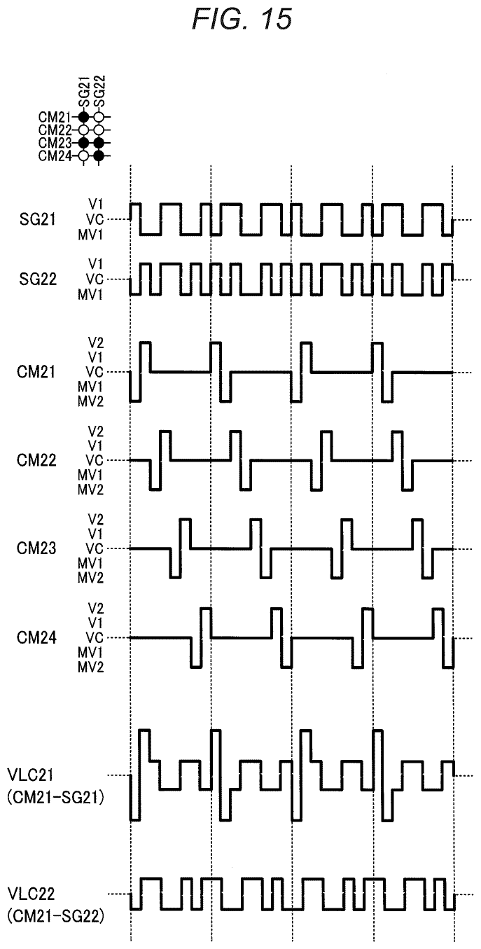

Note that the driving circuit 155 corresponds to one terminal group, as described above. The driving circuit 155 corresponding to the first terminal group is called a first driving circuit, and the driving circuit 155 corresponding to the second terminal group called a second driving circuit. The configuration of the driving circuit 155 is not limited to that shown in FIG. 13. As will be described later with reference to FIGS. 14 and 15, common voltages V1, VC, and MV1 are used in the static driving and the duty driving. The first segment driving circuit 151 and the second segment driving circuit 152 can therefore be configured with a common circuit. In this case, the segment selector 159 may be omitted.

Note that when the terminal groups are each set to operate in a fixed driving method, static driving or duty driving, the segment selector 159 and the common selector 179 in FIG. 13 may be omitted, and the first segment driving circuit 151, the second segment driving circuit 152, the first common driving circuit 171, and the second common driving circuit 172 may be coupled to the terminals.

FIG. 14 shows exemplary signal waveforms in the static driving performed by the first segment driving circuit 151 and the first common driving circuit 171. FIG. 14 shows exemplary signal waveforms used to drive two sets of segment electrodes and common electrodes. Specifically, FIG. 14 shows exemplary signal waveforms in a case where the first set of electrodes to which a segment driving signal SG11 and a common driving signal CM1 are applied are displayed in black, and the second set of electrodes to which a segment driving signal SG12 and the common driving signal CM1 are applied are displayed in white. Note that the description below will be made with reference to normally white display. In the following description, the first set of electrodes is called first segment electrodes and first common electrodes, and the second set of electrodes is called second segment electrodes and second common electrodes.

The first segment driving circuit 151 outputs the segment driving signals SG11 and SG12 shown in FIG. 14 to the first segment electrodes and the second segment electrodes, respectively. The first common driving circuit 171 outputs the common driving signal CM1 to the first common electrodes and the second common electrodes. V1, VC, and MV1 in FIG. 14 represent driving voltages supplied by the driving voltage supplying circuit 160 in FIG. 7. A voltage signal VLC11 corresponding to the difference in voltage between SG11 and CM1 is thus applied to the liquid crystal material between the first segment electrodes and the first common electrodes. A voltage signal VLC12 corresponding to the difference in voltage between SG12 and CM1 is applied to the liquid crystal material between the second segment electrodes and the second common electrodes. Since the normally white display is employed, the voltage signal VLC11 having a high effective voltage is applied to the liquid crystal material between the first segment electrodes and the first common electrodes, so that a displayed object corresponding to the first set of electrodes is displayed in black, which indicates the light-on state. On the other hand, a displayed object corresponding to the second set of electrodes is displayed in white, which indicates the light-off state.

FIG. 15 shows exemplary signal waveforms for duty driving performed by the second segment driving circuit 152 and the second common driving circuit 172. FIG. 15 shows a case where ¼ duty driving is performed and four common signals are used. FIG. 15 shows a case where eight sets of electrodes are displayed by segment driving signals SG21 and SG22 and common driving signals CM21, CM22, CM23, and CM24. Two electrodes driven by the common driving signals CM21, CM22, CM23, and CM24 are called in first-row, second-row, third-row, and fourth-row electrodes, respectively. Four electrodes driven by the segment driving signals SG21 and SG22 are called first-column and second-column electrodes, respectively. For example, the electrodes driven by the common driving signal CM21 and the segment driving signal SG21 are the first-row-first-column electrodes. FIG. 15 shows exemplary signal waveforms in a case where the first-row-first-column electrodes are displayed in black and the first-row-second-column electrodes are displayed in white. In the following description, the first-row-first-column electrodes are called the first segment electrodes and the first common electrodes, and the first-row-second-column electrodes are called the second segment electrodes and the second common electrodes.

In the example shown in FIG. 15, one frame is divided into four subfields, and the common driving signals CM21, CM22, CM23, and CM24 sequentially selected in each of the four subfields. The second segment driving circuit 152 outputs the segment driving signals SG21 and SG22 shown in FIG. 15 to the first segment electrodes and the second segment electrodes, respectively. The second common driving circuit 172 outputs the common drive signal CM21 to the first common electrodes and the second common electrodes. V1, V2, VC, MV1, and MV2 in FIG. 15 represent driving voltages supplied by the driving voltage supplying circuit 160 in FIG. 7. A voltage signal VLC21 corresponding to the difference in voltage between SG21 and CM21 is thus applied to the liquid crystal material between the first segment electrodes and the first common electrodes. A voltage signal VLC22 corresponding to the difference in voltage between SG22 and CM21 is applied to the liquid crystal material between the second segment electrodes and the second common electrodes. When the voltage signal VLC21 having an effective voltage higher than that of VLC22 is applied to the first-row-first-column electrodes, a displayed object corresponding to the first-row-first-column electrodes is displayed in black, which indicates the light-on state. On the other hand, a displayed object corresponding to the first-row-second-column electrodes is displayed in white, which indicates the light-off state.

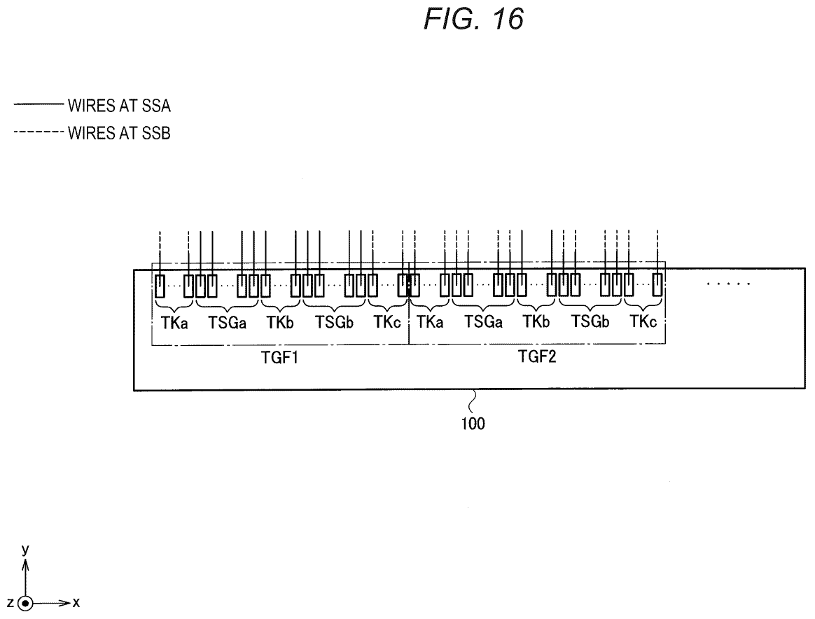

FIG. 16 is a fifth detailed example of the arrangement of the terminals of the driver 100. The driver 100 includes terminal groups TGF1 and TGF2 arranged along the first side HN1. Note that three or more terminal groups may be arranged along the first side HN1. Similar terminal groups may be arranged along the second side HN2.

The terminal groups each include multiple switchable terminals TKa, multiple segment terminals TSGa, multiple switchable terminals TKb, multiple segment terminals TSGb, and multiple switchable terminals TKc sequentially arranged along the first direction x. The switchable terminals TKa, TKb, and TKc each independently enter a state in which the switchable terminals each output the segment driving signal when the control circuit 120 sets the switchable terminals to operate in the segment driving, and enter a state in which the switchable terminals each output the common driving signal when the control circuit 120 sets the switchable terminals to operate in the common driving. FIG. 16 shows a case where the switchable terminals TKa, TKb, and TKc are set to operate in the common driving, the segment driving, and the common driving, respectively, in the terminal group TGF1, and set to operate in the segment driving, the common driving, and the segment driving, respectively, in the terminal group TGF2.

Note in FIG. 16 that the terminal groups TGF1 and TGF2 correspond to the first and second terminal groups described with reference to FIGS. 3 to 5. In each of the terminal groups, the switchable terminals may each be set to operate in any driving method, the segment driving or the common driving.

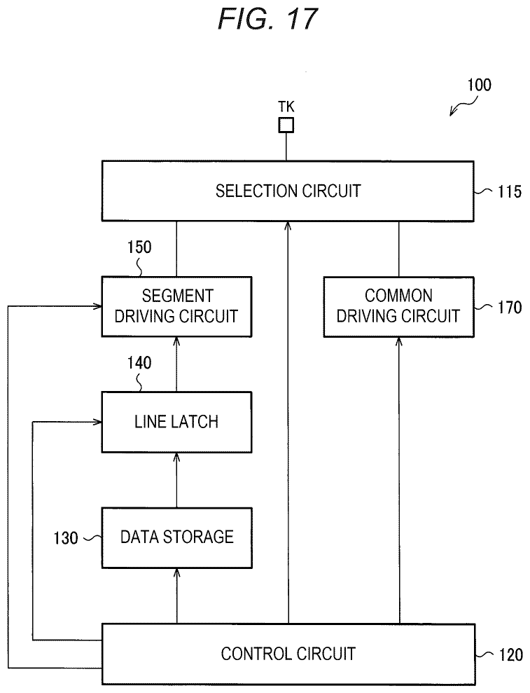

FIG. 17 is a block diagram of a detailed exemplary configuration of the driver 100 using the exemplary terminal arrangement shown in FIG. 16. The driver 100 includes a selection circuit 115, the segment driving circuit 150, the common driving circuit 170, the line latch 140, the data storage 130, and the control circuit 120. Note that FIG. 17 shows a configuration corresponding to one type of the switchable terminals TK. In FIG. 17, the driving voltage supplying circuit 160, the oscillation circuit 190, the interface circuit 110, and the storage circuit 180 are not shown.

The driving method used by the common driving circuit 170 and the segment driving circuit 150 may be either the static driving or the duty driving, or the driving method may be independently set on a terminal group basis as described with reference to FIG. 12 and other figures. The operation of the common driving circuit 170 and the segment driving circuit 150 will be described below with reference to the static driving by way of example.

The common driving circuit 170 outputs the common driving signal based on the timing control signal from the control circuit 120. The timing control signal is, for example, the frame signal indicating a frame. The data storage 130 stores the display data from the control circuit 120. The line latch 140 latches the display data based on the latch signal from the control circuit 120. When the polarity signal from the control circuit 120 indicates the positive polarity, the segment driving circuit 150 does not logically invert the display data latched by the line latch 140, converts the display data not having been logically inverted into a voltage, and outputs the voltage as the segment driving signal. When the polarity signal indicates the negative polarity, the segment driving circuit 150 logically inverts the display data latched by the line latch 140, converts the display data having been logically inverted into a voltage, and outputs the voltage as the segment driving signal. The segment driving circuit 150 performs the logic inversion and the signal output described above based on the timing control signal from the control circuit 120. The timing control signal is, for example, the frame signal. The selection circuit 115 outputs the segment driving signal to the switchable terminals TK when the control signal from the control circuit 120 indicates the segment driving, and outputs the common driving signal to the switchable terminals TK when the control signal indicates the common driving. The selection circuit 115 is, for example, an analog switch circuit using a transistor.

As described with reference to FIGS. 12 to 15, the driver 100 includes the first driving circuit (155 corresponding to TGE1), which outputs one of the segment driving signal for static driving and the segment driving signal for duty driving to the first segment terminal group (TGE1, for example). The driver 100 may include the second driving circuit (155 corresponding to TGE2), which outputs the other one of the segment driving signal for static driving and the segment driving signal for duty driving to the second segment terminal group (TGE2, for example).

According to the present embodiment, a static-driving electrode group capable of high-contrast display and a duty-driving electrode group capable of grayscale display can be arranged in the electro-optical panel 200. The driver 100 includes a static-driving terminal group and a duty-driving terminal each group including common terminals and segment terminals. The configuration described above can support electro-optical panels 200 in which the static-driving electrode group and the duty-driving electrode group are arranged in various types of design.

The first terminal group TG1 and the second terminal group TG2 are adjacent to each other along the first side, as described with reference to FIGS. 3 to 5.

The first segment terminal group (TSG of TGA1) and the second common terminal (TCM of TGA2) may be adjacent to each other along the first side HN1, as described with reference to FIG. 8. Instead, the first common terminal (TCM of TGA1) and the second segment terminal group (TSG of TGA2) may be adjacent to each other along the first side HN1.

The first segment terminal group (TSG of TGA1) and the second segment terminal group (TSG of TGA2) may be adjacent to each other along the first side HN1, as described with reference to FIG. 9. The first common terminal (TCM of TGA1) and the second common terminal (TCM of TGA2) may instead be adjacent to each other along the first side HN1.

As described above, the common terminal and the segment electrode group may be arranged in various manners in each of the terminal groups. Any of the terminal arrangements described above may be selected as appropriate so as to facilitate the wiring in accordance, for example, with the design of the electro-optical panel 200.

As described with reference to FIGS. 16 and 17, the first terminal group (TGF1) may include a first switchable terminal (switchable terminals contained in TKa, for example) as the first common terminal and a second switchable terminal (switchable terminals contained in TKb or TKc, for example). The driver 100 may include the selection circuit 115. The selection circuit 115 may select and output the common driving signal or the segment driving signal to the first switchable terminal, and may select and output the common driving signal or the segment driving signal to the second switchable terminal. In the electro-optical panel 200, the first common electrode group and the first switchable terminal may be coupled to each other, and the selection circuit 115 may output the common driving signal to the first switchable terminal. Instead, in the electro-optical panel 200, the first common electrode group and the second switchable terminal may be coupled to each other, and the selection circuit 115 may output the common driving signal to the second switchable terminal.

According to the present embodiment, the switchable terminal contained in each of the terminal groups can be switched to the common driving or the segment driving in accordance with the design of the electro-optical panel 200. The degree of freedom of the design of the electro-optical panel 200 is thus further improved.

The present embodiment has been described above in detail, and those skilled in the art will easily understand that many variations that do not substantially depart from the novel items and the advantages of the present disclosure are conceivable. It is therefore intended that all such variations fall within the scope of the present disclosure. For example, a term described at least once in the specification or the drawings along with a different term having a broader meaning or the same meaning can be replaced with the different term anywhere in the specification or the drawings. All combinations of the present embodiment and the variations thereof also fall within the scope of the present disclosure. The configurations, operations, and other factors of the driver, the electro-optical panel, the electro-optical device, the processing device, and the electronic apparatus are not limited to those described in the present embodiment, and various variations are conceivable.

What is claimed is:

1. An electro-optical device comprising:
an electro-optical panel; and
a driver configured to drive the electro-optical panel,
wherein the electro-optical panel includes
a transparent first substrate,
a second substrate disposed so as to face the first substrate,
a first segment electrode group arranged at the first substrate,
a second segment electrode group arranged at the second substrate,
a first common electrode group arranged at the second substrate and facing the first segment electrode group, and
a second common electrode group arranged at the first substrate and facing the second segment electrode group,
the driver includes
a first terminal group continuously arranged along a first side of the driver,
a second terminal group continuously arranged along the first side of the driver,
the first terminal group includes
a first segment terminal group configured to supply a segment driving signal to the first segment electrode group, and
a first common terminal configured to supply a common driving signal to the first common electrode group, and
the second terminal group includes
a second segment terminal group configured to supply a segment driving signal to the second segment electrode group, and
a second common terminal configured to supply a common driving signal to the second common electrode group.

2. The electro-optical device according to claim 1, wherein
the electro-optical panel includes
a first segment wire group arranged at the first substrate and configured to couple the first segment electrode group to the first segment terminal group, and
a second segment wire group arranged at the second substrate and configured to couple the second segment electrode group to the second segment terminal group.

3. The electro-optical device according to claim 2, wherein
a region where the first segment wire group is arranged and a region where the second segment wire group is arranged at least partially overlap with each other in a plan view of the electro-optical panel.

4. The electro-optical device according to claim 1, wherein
the electro-optical panel includes
a third segment electrode group arranged at one of the first substrate and the second substrate, and
a third common electrode group arranged at another of the first substrate and the second substrate and facing the third segment electrode group,
the driver includes
a third terminal group continuously arranged along the first side of the driver, and
the third terminal group includes
a third segment terminal group configured to supply a segment driving signal to the third segment electrode group, and
a third common terminal configured to supply a common driving signal to the third common electrode group.

5. The electro-optical device according to claim 1, wherein
the driver includes
a first driving circuit configured to output one of a segment driving signal for static driving and a segment driving signal for duty driving to the first segment terminal group, and
a second driving circuit configured to output another of the segment driving signal for static driving and the segment driving signal for duty driving to the second segment terminal group.

6. The electro-optical device according to claim 1, wherein
the first terminal group and the second terminal group are adjacent to each other along the first side.

7. The electro-optical device according to claim 6, wherein
the first segment terminal group and the second common terminal, or the first common terminal and the second segment terminal group are adjacent to each other along the first side.

8. The electro-optical device according to claim 6, wherein
the first segment terminal group and the second segment terminal group, or the first common terminal and the second common terminal are adjacent to each other along the first side.

9. The electro-optical device according to claim 1, wherein
the first terminal group includes
a first switchable terminal as the first common terminal, and
a second switchable terminal,
the driver includes
a selection circuit configured to select and output a common driving signal or a segment driving signal to the first switchable terminal, and select and output a common driving signal or a segment driving signal to the second switchable terminal,
in the electro-optical panel, the first common electrode group and the first switchable terminal are coupled to each other, and the selection circuit is configured to output the common driving signal to the first switchable terminal, or
in the electro-optical panel, the first common electrode group and the second switchable terminal are coupled to each other, and the selection circuit is configured to output the common driving signal to the second switchable terminal.

10. A driver configured to drive an electro-optical panel, the driver comprising:
a first terminal group continuously arranged along a first side of the driver; and
a second terminal group continuously arranged along the first side of the driver,
wherein the electro-optical panel includes
a transparent first substrate,
a second substrate disposed so as to face the first substrate,
a first segment electrode group arranged at the first substrate,
a second segment electrode group arranged at the second substrate,
a first common electrode group arranged at the second substrate and facing the first segment electrode group, and
a second common electrode group arranged at the first substrate and facing the second segment electrode group,
the first terminal group includes
a first segment terminal group configured to supply a segment driving signal to the first segment electrode group, and
a first common terminal configured to supply a common driving signal to the first common electrode group, and
the second terminal group includes
a second segment terminal group configured to supply a segment driving signal to the second segment electrode group, and
a second common terminal configured to supply a common driving signal to the second common electrode group.

11. An electro-optical panel driven by a driver, the electro-optical panel comprising:
a transparent first substrate;
a second substrate disposed so as to face the first substrate;
a first segment electrode group arranged at the first substrate;
a second segment electrode group arranged at the second substrate;
a first common electrode group arranged at the second substrate and facing the first segment electrode group;
a second common electrode group arranged at the first substrate and facing the second segment electrode group;
a first panel-side terminal group coupled to the first segment electrode group and the first common electrode group; and
a second panel-side terminal group coupled to the second segment electrode group and the second common electrode group,
the driver includes
a first terminal group including a first segment terminal group configured to supply a segment driving signal to the first segment electrode group, and a first common terminal configured to supply a common driving signal to the first common electrode group, the first terminal group continuously arranged along a first side of the driver, and
a second terminal group including a second segment terminal group configured to supply a segment driving signal to the second segment electrode group, and a second common terminal configured to supply a common driving signal to the second common electrode group, the second terminal group continuously arranged along the first side of the driver,
the first panel-side terminal group is coupled to the first terminal group, and
the second panel-side terminal group is coupled to the second terminal group.
